(19) United States
(12) Patent Application Publication
(10) Pub. No.: US 2006/0206491 A1
(43) Pub. Date: Sep. 14, 2006

(54) Mask recovering system and mask recovering method

(75) Inventors: Kazutaka Sakamoto, Akishima (JP); Masaru Morio, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/373,257

(22) Filed: Mar. 13, 2006

(30) Foreign Application Priority Data
Mar. 14, 2005 (JP) 2005-071324
Sep. 20, 2005 (JP) 2005-272254

(51) Int. Cl. G06F 17/30; G06F 7/00

(52) U.S. Cl. 707/10

(57) ABSTRACT

A mask disposing system is configured in the following manner. A server receives a request to dispose of a mask to be discontinued from a client terminal through a network, provides instructions to take the mask out to a storage cabinet, provides instructions to dispose of the mask to a disposing unit, and provides a disposal verifying information from a disposal verifying unit to the client terminal. The storage cabinet stores the mask. The disposing unit disposes of the mask by crushing the mask pattern on the mask so that the mask pattern becomes unreadable. The disposal verifying unit verifies that the mask has been crushed and disposed of.

### CROSS-REFERENCE TO RELATED APPLICATIONS

This applications is based on, and claims prioryty to, Japanese patent application 2005-272254, filed Sep. 20, 2005, in Japan, and which is incorporated herein by reference.

This applications is based on, and claims prioryty to, Japanese patent application 2005-71324, filed March 14, in Japan, and which is incorporated herein by reference.

### BACKGROUND OF THE INVENTION

1. Field of the Invention

The present invention relates to management of photomasks for exposure (hereinafter referred to as masks) used to manufacture semiconductor devices, particularly to a safe method of disposing masks for in-house use and masks used in entrusted business in which the security is strictly managed.

2. Description of the Related Art

A semiconductor device manufacturing plant that performs exposure using masks and a plurality of departments: a department of designing the masks and a department of ordering the masks, relate to the masks used in an exposure step of a wafer process in a process of manufacturing semiconductor chips to be mounted on semiconductor devices. In other words, it is common that masks are designed in-house but the manufacturing thereof is ordered to a mask manufacturer.

In a site of manufacturing semiconductor chips by using masks, masks for exposure used to manufacture semiconductor devices are called reticles. A set of several tens of reticles is used for each type of semiconductor device. These reticles, which are revised in respective layers, are used in combination. Therefore, the management of the reticles is very important, and a method for carefully managing reticles in use and discontinued reticles has been proposed (see Patent Document 1: Japanese Unexamined Patent Application Publication No. 2004-70026 (“Claims” and “Detailed description of the Invention”)).

Masks used to manufacture semiconductor devices are recognized as a kind of products of copyright having company secrets. Therefore, with a recent enhancement of security in semiconductor devices, how to manage masks in a manufacturing site has been becoming more and more important.

In addition, when masks of discontinued semiconductor devices are disposed of and abandoned by peeling mask patterns thereon, the disposal of each mask needs to be verified for the purpose of security.

Conventionally, the following four methods have been mainly used as a method for verifying that a mask has been reliably disposed of.

(1) The mask is mechanically crushed, the image thereof is taken by a camera, and the image data is transmitted to a client.

(2) The mask itself is returned to a client.

(3) The mask is crushed in the presence of a client.

(4) A device pattern is peeled off to obtain a bare glass substrate in the presence of a client.

When discussing these conventional methods for disposing masks to be securely managed, some problems arise.

That is, in the conventional disposing method (1), it is difficult to verify that the mask has been reliably crushed based on the image data of the crushed mask. Particularly, the mask that is securely managed needs to be reliably abandoned in order to protect the business of the client. Further, the crushed mask is abandoned with a Cr film or the like being attached thereto, which causes an environmental problem.

In the conventional disposing method (2), when a client is a foreign client, various documents need to be prepared due to the regulations of foreign exchange and foreign trade law and thus many processes are required to be done in order to return the mask. Further, the returned mask needs to be abandoned by the client, which is inconvenient.

In the conventional disposing methods (3) and (4), the client needs to come to the site of disposal every time a mask is disposed of, which imposes a significant burden on the client in terms of time and cost.

On the other hand, a semiconductor device manufacturer stores many masks, and thus storing discontinued masks leads to wastes of load and cost of a storage place and management.

### SUMMARY OF THE INVENTION

Accordingly, the present invention is directed to providing a disposing system that reliably performs a series of disposal operations including: receiving a request to dispose of a mask from a client terminal; providing instructions to take the mask out of a storage cabinet and to dispose of the mask by a disposing unit; verifying and registering a disposal track record by a disposal verifying unit; and browsing the disposal track record by the client, by using a server and saving the manpower.

In order to solve the above-described problems, there is provided a mask disposing system including: a server; a storage cabinet; a disposing unit; and a disposal verifying unit. The server receives a request to dispose of a mask from a terminal through a network, provides instructions to take the mask out of storage to the storage cabinet, provides instructions to dispose of the mask to the disposing unit, and provides disposal verifying information from the disposal verifying unit to the terminal. The storage cabinet stores the mask. The disposing unit crushes a mask pattern formed on the mask so that the mask pattern becomes unreadable. The disposal verifying unit verifies that the mask has been crushed and disposed of.

That is, a request to dispose of a mask to be discontinued transmitted from the client terminal is accepted by the server through the network. Then, the server provides instructions to take the mask out of storage to the storage cabinet and also provides instructions to crush the mask to the disposing unit. The disposing unit crushes the mask so that the pattern formed thereon becomes unreadable. The disposal verifying unit transmits disposal completion information such as image data, so that the client can verify the completion of disposal by seeing the image data.

According to the present invention, the client can transmit a request to dispose of an unnecessary mask or a mask to be discontinued and verify the completion of disposal through a network. The disposal request from the client is transmitted to the storage cabinet and the disposing unit by the server connected through a network. Further, information indicating that the mask has been reliably disposed of is registered by the disposal verifying unit, so that the client can browse the information.

Accordingly, the movement of people and expenditure of time required to dispose of masks can be minimized, and thus the reliability and efficiency of the disposing process can be enhanced.

According to the mask disposing system and mask disposing method of the present invention, a disposing process and a disposal verifying process for discontinued masks can be performed by a server serving as the core of the system, while minimizing the manpower and saving time.

Therefore, the present invention significantly contributes to enhance the reliability and efficiency of a mask disposing process in which security protection is important.

### BRIEF DESCRIPTION OF THE DRAWINGS

FIG. 1 is a schematic view of a disposing system according to a first embodiment of the present invention;

FIG. 2 is a schematic view of a disposing system according to a second embodiment of the present invention;

FIG. 3 is a schematic view of a disposing system according to a third embodiment of the present invention;

FIG. 4 is a schematic view of a disposing system according to a fourth embodiment of the present invention;

FIG. 5 is a schematic view of a disposing system according to a fifth embodiment of the present invention;

FIGS. 6A to 6D show the configuration of a mask management database 120 included in a server 12 according to the first embodiment;

FIG. 7 is a flowchart of a process performed in the server 12 according to the first, third, fourth, and fifth embodiments;

FIG. 8 is a flowchart of a process performed in a server 13 according to the first, second, fourth, and fifth embodiments;

FIG. 9 is a flowchart (2) of a process performed in the server 12 according to the first and third embodiments;

FIGS. 10A to 10E show the configuration of the mask management database 120 included in the server 12 according to the second embodiment;

FIG. 11 is a flowchart of a process performed in the server 12 according to the second embodiment;

FIG. 12 is a flowchart (2) of a process performed in the server 12 according to the second embodiment;

FIGS. 13A to 13D show the configuration of the mask management database 120 included in the server 12 according to the third embodiment;

FIG. 14 is a flowchart of a process performed in the server 13 according to the third embodiment;

FIGS. 15A to 15D show the configuration of the mask management database 120 included in the server 12 according to the fourth embodiment;

FIG. 16 is a flowchart (2) of a process performed in the server 12 according to the fourth embodiment;

FIGS. 17A to 17E show the configuration of the mask management database 120 included in the server 12 according to the fifth embodiment;

FIG. 18 shows an example of the configuration of a peeling operation database 130 included in the server 13 according to the first embodiment;

FIG. 19 shows an example of the configuration of the peeling operation database 130 included in the server 13 according to the third embodiment; and

FIG. 20 is a flowchart (2) of a process performed in the server 12 according to the fifth embodiment.

### DESCRIPTION OF THE PREFERRED EMBODIMENTS

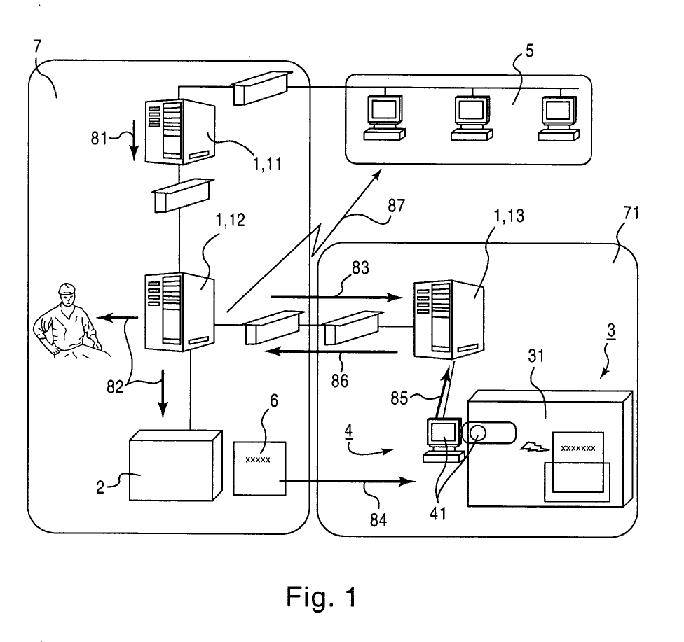

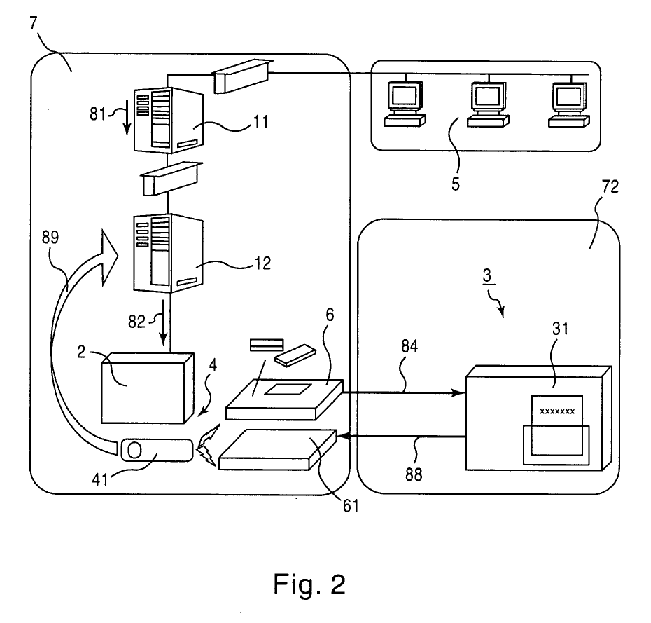

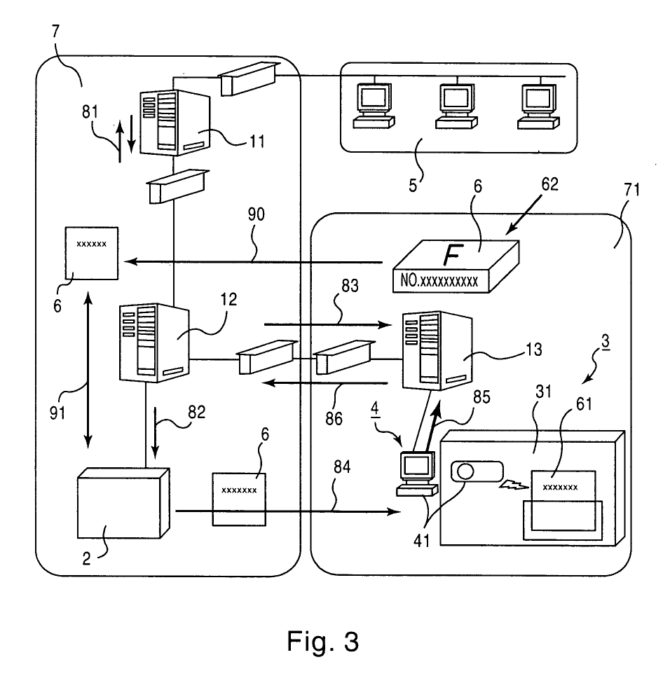

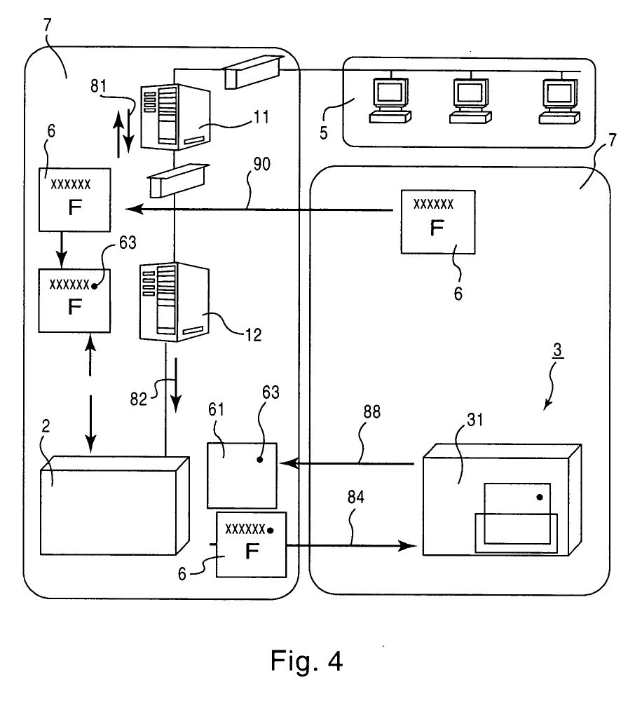

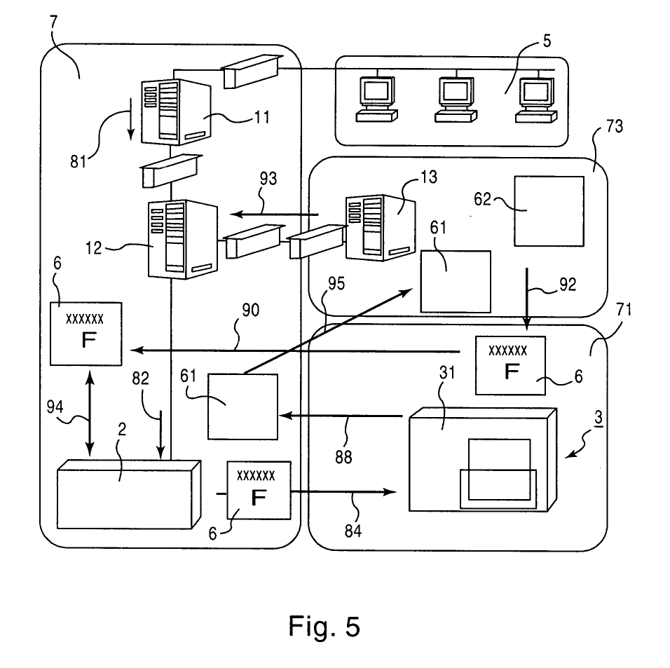

FIG. 1 is a schematic view of a disposing system according to a first embodiment of the present invention, FIG. 2 is a schematic view of a disposing system according to a second embodiment of the present invention, FIG. 3 is a schematic view of a disposing system according to a third embodiment of,the present invention, FIG. 4 is a schematic view of a disposing system according to a fourth embodiment of the present invention, and FIG. 5 is a schematic view of a disposing system according to a fifth embodiment of the present invention.

In the figures, reference numeral 1 denotes a server, 11 denotes a first server, 12 denotes a second server, 13 denotes a third server, 2 denotes a storage cabinet, 3 denotes a disposing unit, 31 denotes a disposing device, 4 denotes a disposal verifying unit, 41 denotes a disposal verifying device, 5 denotes a client terminal, 6 denotes a mask, 61 denotes a bare glass substrate, 7 denotes a semiconductor device manufacturer, 71 denotes a mask manufacturer, 72 denotes a mask disposing company, 73 denotes a mask substrate manufacturer, and 81 to 95 denote arrows.

The arrows 81 to 95 in the figures schematically indicate the flows and directions of information including instructions, digital data of images and numerical values, or other specific information transmitted from an element to an element.

The hardware constituting each of the first server 11, the second server 12, and the third server 13 of the present invention includes a CPU (central processing unit), a ROM (read only memory), a RAM (random access memory), an HDD (hard disk drive), an HD (hard disk), an FDD (flexible disk drive), an FD (flexible disk) as an example of a removable recording medium, a display, an I/F (interface), a keyboard, and a mouse. These respective units are connected through a bus.

The CPU of each of the first server 11, the second server 12, and the third server 13 controls the server. The ROM stores programs including a boot program. The RAM is used as a work area of the CPU. The HDD controls read/write of data from/on the HD under control by the CPU. The HD stores data written under control by the HDD. The FDD controls read/write of data from/on the FD under control by the CPU. The FD stores data written under control by the FDD and allows an information processing apparatus to read the data recorded on the FD. A removable recording medium other than the FD may also be used, e.g., a CD-ROM (CD-R, CD-RW), an MO (magnetooptical disc), a DVD (digital versatile disk), or a memory card. The display displays a cursor, icons, tool boxes, and windows (browsers) relating to data of documents, images, and function information. Examples of the display include a CRT (cathode ray tube), a TFT (thin-film transistor) liquid crystal display, and a plasma display. These functions are realized when the CPU executes a mask disposal management program stored in the ROM, RAM, HD, or FD.

Part of various data and data tables stored in a mask management database 120 and a peeling operation database 130 may be generated in or erased from the RAM, which is used as a work area, as necessary.

The I/F connects to a network, such as a LAN or the Internet, through a communication line, and also connects to another information processing apparatus (e.g., a server) through the network.

The I/F functions as an interface between the network and the inside of the apparatus and controls input/output of data to/from another server or information terminal apparatus. Specifically, the I/F is a modem or the like. When an information providing apparatus performs wireless communication with a mobile phone or the like, the I/F also functions as a communication device (wireless transceiver).

The keyboard is provided with keys to input characters, numerals, and various instructions, and is used to input data. The keyboard may be replaced by a touch-panel-type input pad. The mouse is used to move the cursor, select a range, move a window, or change the size of the window. A. device other than the mouse may also be used if it has a similar function of a pointing device, e.g., a track ball or a joy stick.

### First Embodiment

In FIG. 1, three servers as the servers 1 connect to each other through the network. The first server 11 and the second server 12 are placed in a company A, whereas the third server 13 is placed in a company B. In the example shown here, the company A is a semiconductor device manufacturer 7 and the company B is a mask manufacturer 71, which has the disposing unit 3 and the disposal verifying unit 4.

When a client accesses the first server 11 of the company A from the client terminal 5 in order to request disposal of the mask 6, the disposal request is transmitted to the second server 12 along the arrow 81 and is registered therein. Then, the second server 12 transmits the disposal request to a person involved and the storage cabinet 2 along the arrows 82 and to the third server 13 placed in the company B along the arrow 83. The storage cabinet 2 takes the specified mask 6 out of storage and transmits the mask 6 to the company B along the arrow 84.

The company B receives the mask 6 and performs a disposal operation by using the disposing unit 3. In order to dispose of the mask 6, the mask 6 may be mechanically crushed. However, the typical disposing unit 3 peels a Cr pattern or an emulsion pattern on the mask off the substrate so that the pattern becomes unreadable. For example, the disposing device 31 to perform peeling with agent is used.

After the peeling and disposal of the mask 6 have been done, the disposal verifying unit 4 performs verification so as to verify that the mask 6 has been reliably disposed of. Typically, the verification is performed by using the disposal verifying device 41, such as a video camera. The image taken by the video camera is converted to digital data, which is then transmitted to the third server 13 along the arrow 85 and is registered therein.

The third server 13 transmits the disposal verifying information, serving as disposal track record information, registered by the disposal verifying unit 4 to the second server 12 of the company A along the arrow 86. The second server 12 registers the received disposal track record information therein so that the client can browse it and notifies the client terminal 5 by e-mail that disposal has completed along the arrow 87. Accordingly, the client can appropriately obtain the disposal track record information registered in the second server 12 through the client terminal 5 by accessing the first server 11.

According to the procedure of the first embodiment, the client only has to input a disposal request from the client terminal 5 to the first server 11 of the company A as the semiconductor device manufacturer 7. The client does not need to do further operations, which is convenient.

Further, the company A can obtain disposal track record information and register it in the second server 12 by transmitting a disposal request from the first server 11 to the company B as the mask manufacturer 71 through the second server 12 and transmitting the mask 6 that is requested to be disposed of from the client.

The details are described below.

The second server 12 of the company A as the semiconductor device manufacturer 7 includes the mask management database 120. The mask management database 120 manages information about the mask 6 and the disposal status of the mask 6.

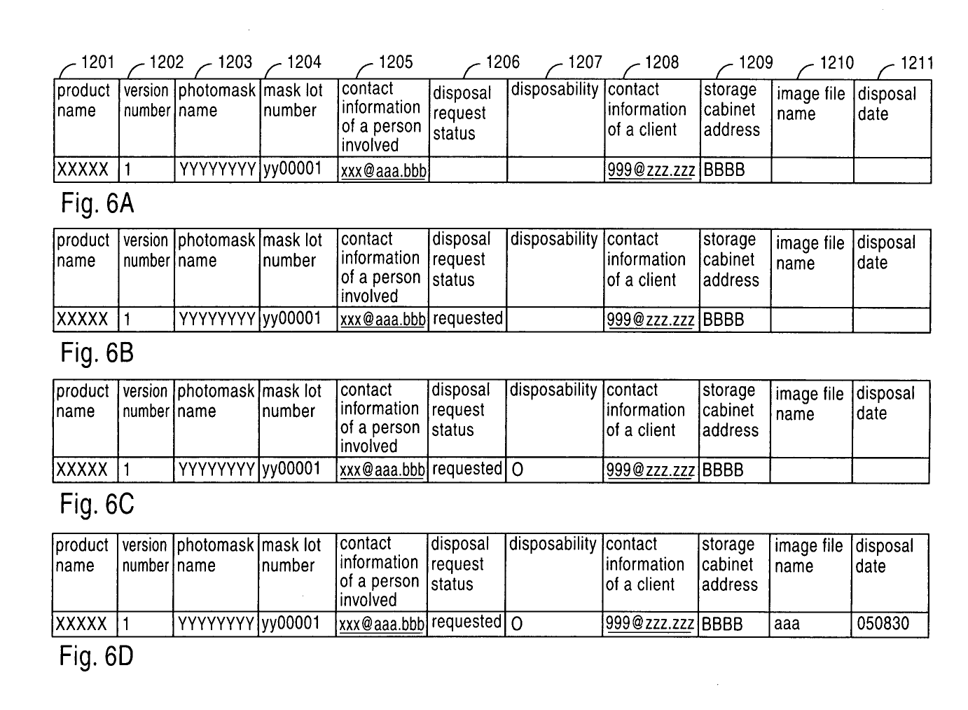

FIGS. 6A to 6D show the configuration of the mask management database 120 included in the second server 12 of the first embodiment.

The mask management database 120 is composed of the following items: product name 1201, version number 1202, photomask name 1203, mask lot number 1204, contact information of a person involved 1205, disposal request status 1206, disposability 1207, contact information of a client 1208, storage cabinet address 1209, image file name 1210, and disposal date 1211.

The product name 1201 is used to identify a semiconductor product. A number may also be used if the product can be identified thereby. The version number 1202 is the version number of a semiconductor product or the mask 6.

The photomask name 1203 is used to identify each mask 6. A semiconductor product may be manufactured with a plurality of masks 6, so that the names of the respective masks 6 are managed in the database. The mask lot number 1204 is a number assigned to each mask 6.

The contact information of a person involved 1205 is the contact information of a person who manages manufacturing a semiconductor device corresponding to the present data record of the mask management database 120. The person involved means a person in charge of manufacturing the semiconductor device corresponding to the mask 6 in the semiconductor device manufacturer. The contact information includes an e-mail address, a telephone number, or a fax number. The person involved may be a department of the company or a plurality of persons. The contact information can be in conjunction with a staff management server.

The disposal request status 1206 is the information indicating that disposal is requested when a client requests disposal of the mask 6.

The disposability 1207 is the information registered after the person in charge of the specified mask 6 determined whether the mask 6 can be disposed of in response to a disposal request from the client. Whether the mask 6 can be disposed of is determined based on this information. This information is used as countermeasures against a case where the client wrongly provides instructions.

The contact information of a client 1208 is the contact information of a client who ordered to manufacture the semiconductor product, and includes the name of a client company, the e-mail address of the client, the fax number of the client, or the telephone number of the client. The contact includes a contact with the client terminal 5. A client management database is also provided separately, so that the client management database can be accessed by using a client identifier.

The storage cabinet address 1209 is the address of the storage cabinet 2 storing the mask 6. The storage cabinet address 1209 is determined and is registered in the mask management database 120 when the mask 6 is supplied, for example. When a plurality of storage cabinets 2 exist, an address is assigned to each of the storage cabinets 2.

The image file name 1210 is the name of an image file, which is generated by taking an image of a peeled mask 6 and is registered in the mask management database 120.

The disposal date 1211 is the date when a peeling process was completed in the company B.

Next, a registration status of the mask management database 120 before a mask disposal process starts is described.

After receiving an order to newly manufacture a semiconductor device from a client, the company A is supplied with the mask 6. At this time, the product name 1201, the version number 1202, the photomask name 1203, the mask lot number 1204, the contact information of a person involved 1205, the contact information of the client 1208, and the storage cabinet address 1209 are registered in the mask management database 120 of the second server 12.

FIG. 6A shows a status where the above-described information is registered in the mask management database 120.

Then, the company A continues manufacturing as usual until the client requests disposal of the mask.

Next, a process of disposing the mask 6 is described.

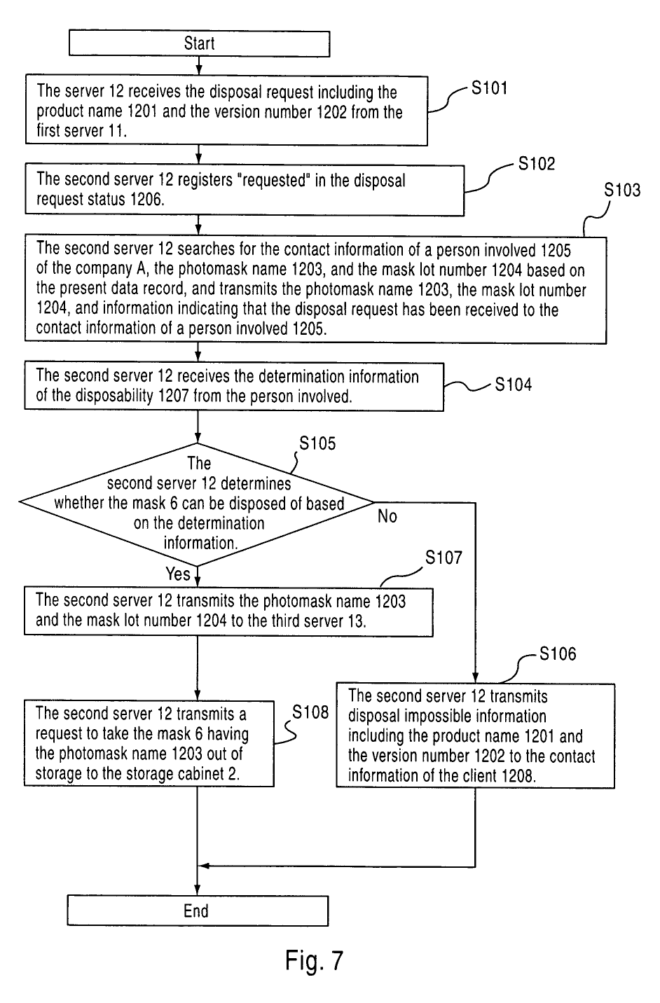

FIG. 7 is a flowchart of a process performed in the second server 12 according to the first, third, fourth, and fifth embodiments.

This flowchart illustrates a process performed after the company A receives a request to dispose of the mask 6 from a client until the company A transmits the mask 6 to the company B.

When the client wants to dispose of the mask 6, the client inputs a client ID, a password, and so on to the client terminal 5 in order to log in a mask disposal accepting system provided in the first server 11, which is a server of the company A for outside people involved. The mask disposal accepting system accepts the request to dispose of the mask 6. Also, if the client requests browsing image data of the mask 6 after the mask 6 has been disposed of, the mask disposal accepting system, displays the image data. The client inputs the product name 1201 and the version number 1202 of the semiconductor device corresponding to the mask 6 to be disposed of to the client terminal 5 and transmits a disposal request to the first server 11.

The first server 11 receives the disposal request including the product name 1201 and the version number 1202 of the semiconductor device from the client, and then transmits the product name 1201 and the version number 1202 to the second server 12, which is a server for inside staff involved.

The second server 12 determines whether a data record corresponding to the received product name 1201 and version number 1202 exists in the mask management database 120. If the data record does not exist, the second server 12 transmits information indicating that the data record does not exist to the first server 11 and requests re-input.

At the time when the client logs in the mask disposal accepting system in the first server 11, the client can be identified, a data record in the mask management database 120 of the second server 12 can be searched for the product name 1201 and the version number 1202 corresponding to the client information, and a list of semiconductor products can be displayed on the screen of the client terminal 5. In this case, one of the semiconductor products displayed on the screen can be selected by the client.

On the other hand, if the second server 12 determines that the mask management database 120 has the data record corresponding to the product name 1201 and the version number 1202 received from the first server 11, the second server 12 receives the disposal request including the product name 1201 and the version number 1202 from the first server 11 (S101).

After receiving the disposal request, the second server 12 registers “requested” in the disposal request status 1206 in the mask management database 120 (S102).

FIG. 6B shows a status where “requested” is registered in the disposal request status 1206 in the mask management database 120.

Then, the second server 12 searches for the contact information of a person involved 1205 of the company A, the photomask name 1203, and the mask lot number 1204 based on the present data record, and transmits the photomask name 1203, the mask lot number 1204, and information indicating that the disposal request has been received to the contact information of a person involved 1205 (S103).

The person involved receives the notification in step S103, determines whether the mask can be disposed of based on the photomask name 1203 and the mask lot number 1204, and transmits the determination result as determination information of the disposability 1207 in the mask management database 120 to the second server 12. The second server 12 receives the determination information of the disposability 1207 from the person involved (S104) and determines whether the mask 6 can be disposed of based on the determination information (S105).

FIG. 6C shows a status where the disposability 1207 is registered in the mask management database 120.

If the determination information of the disposability 1207 of the mask 6 received from the person involved indicates “impossible” (No in step S105), the second server 12 transmits disposal impossible information including the product name 1201 and the version number 1202 to the contact information of the client 1208 (S106). On the other hand, if the determination information of the disposability 1207 of the mask 6 received from the person involved indicates “possible” (Yes in step S105), the second server 12 transmits the photomask name 1203 and the mask lot number 1204 to the third server 13 of the company B as a prior announcement of disposal of the mask 6 (S107).

The second server 12 transmits a request to take the mask 6 having the photomask name 1203 out of storage to the storage cabinet 2. The request includes the storage cabinet address 1209 in the data record in the mask management database 120 (S108). In response to the request, the storage cabinet 2 takes the mask 6 corresponding to the storage cabinet address 1209 out of the storage cabinet 2.

The taken mask 6 is transmitted to the company B.

Next, a process of disposing the mask 6 performed in the company B, which is the mask manufacturer 71, is described.

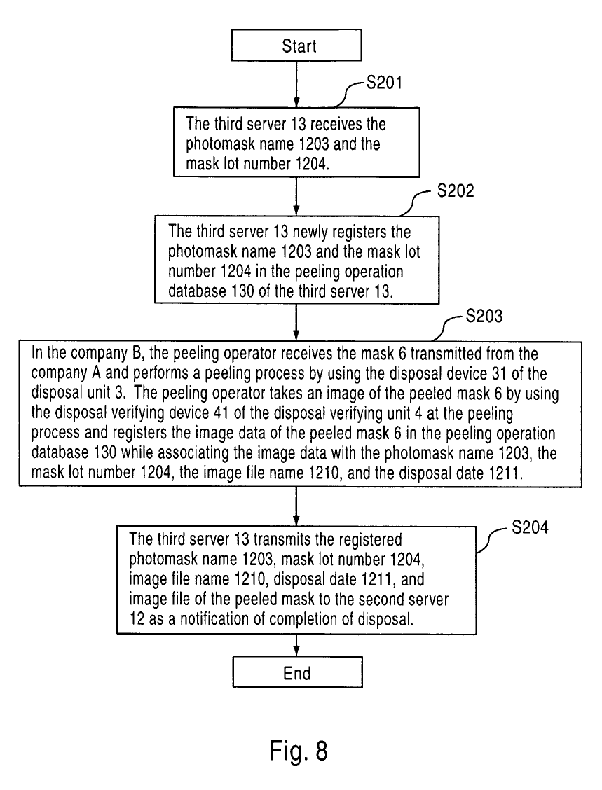

FIG. 8 is a flowchart of a process performed in the third server 13 according to the first, second, fourth, and fifth embodiments. This relates to a process of disposing the mask 6 performed in the company B according to the first embodiment.

The third server 13 of the company B receives the photomask name 1203 and the mask lot number 1204 transmitted from the second server 12 in step S107 (S201) and newly registers the received information in the peeling operation database 130 of the third server 13 (S202).

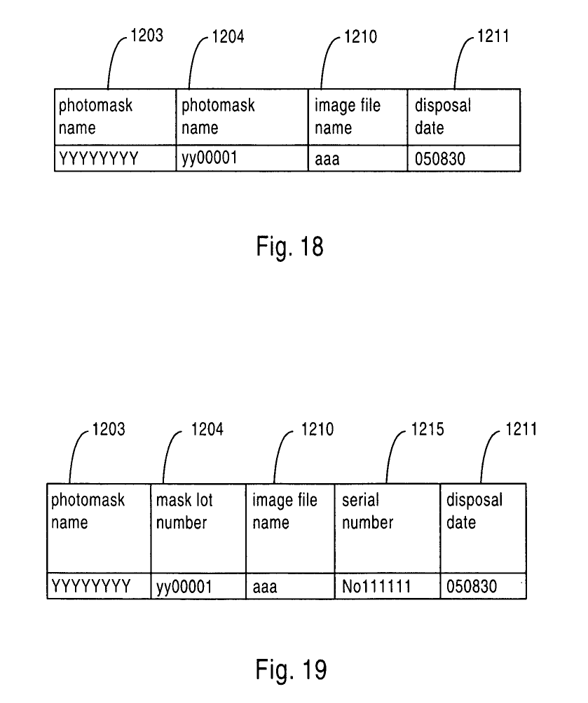

FIG. 18 shows an example of the configuration of the peeling operation database 130 included in the third server 13 according to the first embodiment.

The peeling operation database 130 stores the image file name 1210 and the disposal date 1211 as a data record, with the photomask name 1203 and the mask lot number 1204 being the reference.

A peeling operator of the company B relating to the mask 6 receives the mask 6 transmitted from the company A and performs a peeling process on the mask by using the disposing device 31 of the disposing unit 3. At this time, the disposal verifying device 41 of the disposal verifying unit 4 obtains image data of the peeling process.

In the company B, the peeling operator receives the mask 6 transmitted from the company A and performs a peeling process by using the disposing device 31 of the disposing unit 3. The peeling operator takes an image of the peeled mask 6 by using the disposal verifying device 41 of the disposal verifying unit 4 at the peeling process and registers the image data of the peeled mask 6 in the peeling operation database 130 while associating the image data with the photomask name 1203, the mask lot number 1204, the image file name 1210, and the disposal date 1211 (S203).

The third server 13 transmits the registered photomask name 1203, mask lot number 1204, image file name 1210, disposal date 1211, and image file of the peeled mask to the second server 12 as a notification of completion of disposal (S204).

Next, a process of registering the image of the peeled mask in the company A is described.

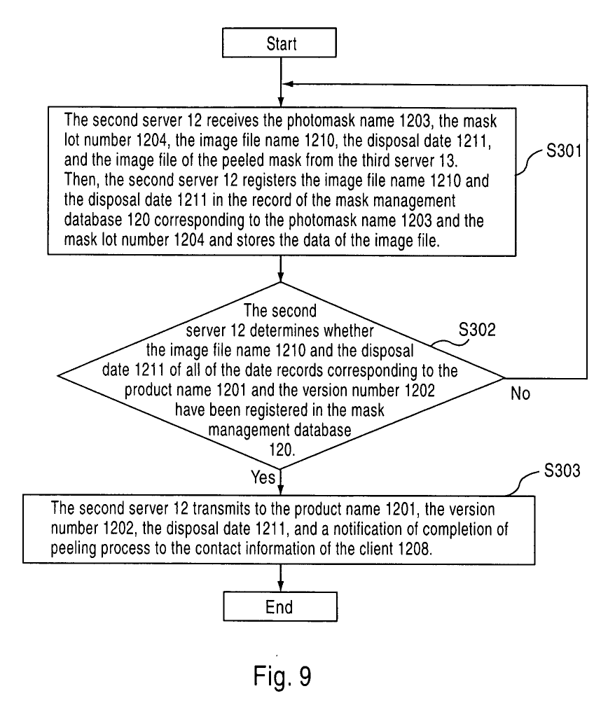

FIG. 9 is a flowchart (2) of a process performed in the server 12 according to the first and third embodiments. This flowchart illustrates a process of registering an image of a peeled mask performed in the company A after being notified from the company B that disposal has completed.

The second server 12 receives the photomask name 1203, the mask lot number 1204, the image file name 1210, the disposal date 1211, and the image file of the peeled mask from the third server 13. Then, the second server 12 registers the image file name 1210 and the disposal date 1211 in the record of the mask management database 120 corresponding to the photomask name 1203 and the mask lot number 1204 and stores the data of the image file (S301).

FIG. 6D shows a status where the image file name 1210 and the disposal date 1211 are registered in the mask management database 120.

The second server 12 determines whether all of the masks 6 corresponding to the product name 1201 and the version number 1202 requested to be disposed of have been registered as disposed of masks, that is, whether the image file name 1210 and the disposal date 1211 of all of the data records corresponding to the product name 1201 and the version number 1202 have been registered in the mask management database 120 (S302).

If not all of the masks have been disposed of (No in step S302), the process waits until the disposal of all of the masks 6 has been registered. On the other hand, if all of the masks 6 have been disposed of (Yes in step S302), the product name 1201, the version number 1202, the disposal date 1211, and a notification of completion of peeling process are transmitted to the contact information of the client 1208 (S303).

In step S302, the notification may be transmitted to the client every time one mask 6 has been disposed of. In step S303, the information and notification may be directly transmitted from the second server 12 to the client terminal 5 or may be transmitted through the first server 11 to the client terminal 5.

By performing the above-described process, the company A can easily manage the result of a peeling process and automatically notify the client of the result.

When the client wants to see the image of the peeled mask 6, the client logs in the mask disposal accepting system of the first server 11 through the client terminal 5 and inputs the product name 1201, the version number 1202, and an image browsing request.

The second server 12 receives the product name 1201, the version number 1202, and the image browsing request from the first server 11, extracts a data record corresponding to the product name 1201 and the version number 1202 from the mask management database 120, reads the image file name 1210 of the data record, and transmits the image file corresponding to the image file name 1210 to the first server 11.

### Second Embodiment

In FIG. 2, two servers connect to each other through a network. The first server 11 and the second server 12 are placed in the company A, which is also provided with the disposal verifying unit 4. The company B includes the disposing unit 3. That is, in the example shown here, the company A is the semiconductor device manufacturer 7 and the company B is the mask disposing company 72.

If the client accesses the first server 11 of the company A from the client terminal 5 in order to request disposal of the mask 6 to be discontinued, the request is registered in the second server 12. At this time, a character that is arbitrarily specified by the client is registered together. In the storage cabinet 2, the specified mask 6 is taken out therefrom. The disposal verifying unit 4 inscribes the character specified by the client on the mask 6 near a mask ID by using laser. Then, the disposal verifying device 41 such as a video camera takes an image of the mask 6 with the character in one frame and transmits the mask 6 to the company B along the arrow 84.

The company B receives the mask 6 and performs a disposal process by using the disposing unit 3. In order to dispose of the mask 6, the mask 6 may be mechanically crushed. However, the typical disposing unit 3 peels a Cr pattern or an emulsion pattern on the mask off the substrate so that the pattern becomes unreadable. For example, the disposing device 31 to perform peeling with agent is used. After disposing the mask 6 by peeling it, the company B transmits the bare glass substrate 61 to the company A along the arrow 88.

The company A receives the bare glass substrate 61. Then, the disposal verifying unit 4 performs verification again so as to verify that the mask 6 has been reliably disposed of. Typically, the verification is performed by the disposal verifying device 41 such as a video camera. The image of the bare glass substrate 61 with the character specified by the client is converted to digital data and is transmitted to the second server 12 along the arrow 89, and is then registered therein.

Accordingly, by accessing the first server 11 through the client terminal 5, the client can verify that the disposal process has reliably been done by comparing the image of the specified character registered in the second server 12, that is, the disposed of bare glass substrate 61, with the image of the original mask 6.

The second server 12 includes the mask management database 120.

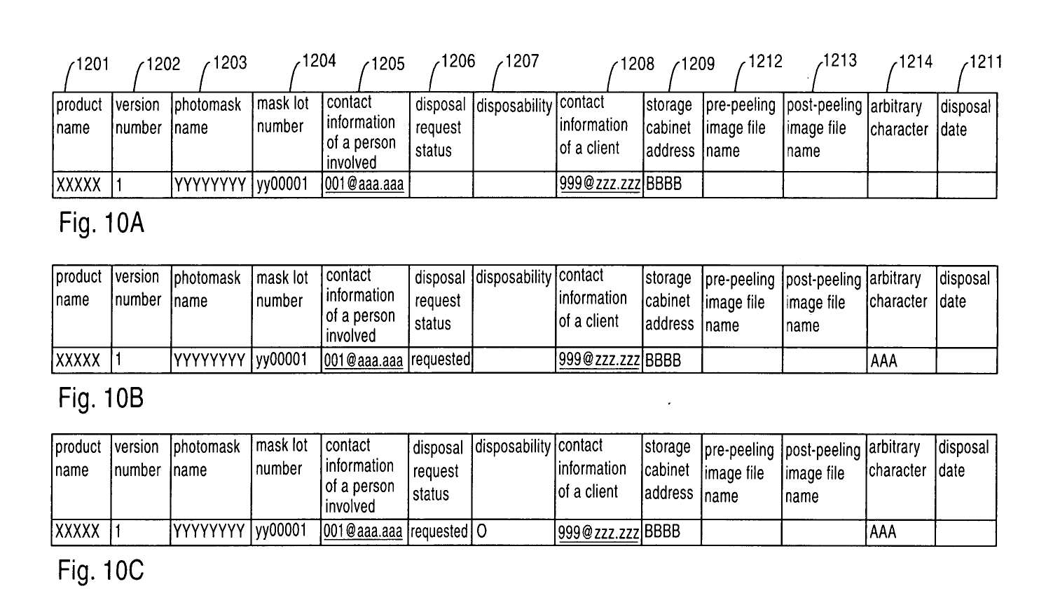

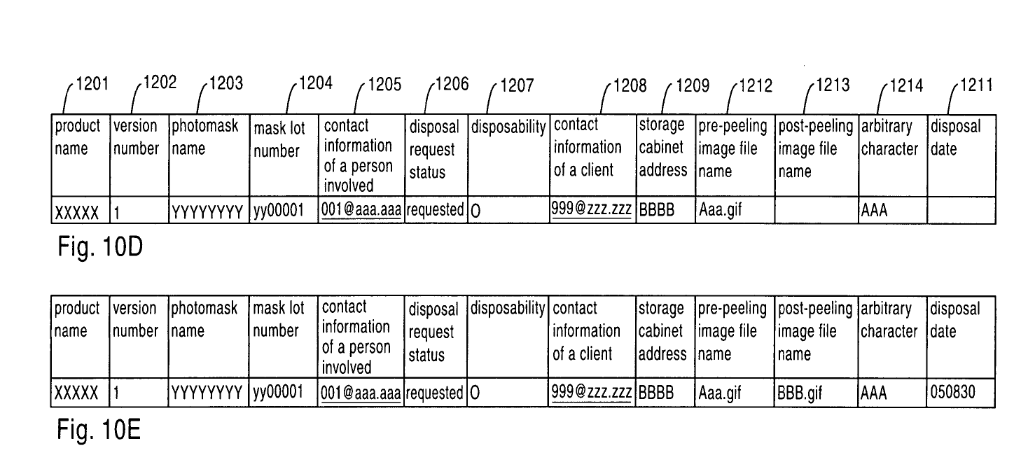

FIGS. 10A to 10E show the configuration of the mask management database 120 included in the second server 12 according to the second embodiment.

The mask management database 120 is composed of the following items: product name 1201, version number 1202, photomask name 1203, mask lot number 1204, contact information of a person involved 1205, disposal request status 1206, disposability 1207, contact information of a client 1208, storage cabinet address 1209, pre-peeling image file name 1212, post-peeling image file name 1213, arbitrary character 1214, and disposal date 1211.

Among these items constituting the mask management database 120, the same items as those in the first embodiment have the same function, and thus the corresponding description is not repeated.

The mask management database 120 of the second embodiment is different from that of the first embodiment in having the pre-peeling image file name 1212, the post-peeling image file name 1213, and the arbitrary character 1214.

The pre-peeling image file name 1212 is the name of an image data file recording the image of the mask 6 before peeling. More specifically, the arbitrary character 1214 is inscribed with a CO₂ laser on the mask 6 before peeling, the mask 6 is shot such that the arbitrary character 1214 inscribed on the mask 6 can be recognized, and the obtained image is converted to image data.

The post-peeling image file name 1213 is the name of an image data file recording the image of the mask 6 after peeling. This image is taken so that the layout therein is the same as that in the image of the mask 6 before peeling.

The arbitrary character 1214 is an arbitrary character string that is input by the client to request disposal. A figure may by used instead of a character string, but a character string is used in this embodiment. Different character strings may be assigned to respective masks.

Next, a registration status of the mask management database 120 before a mask disposing process starts is described.

After receiving an order to manufacture a semiconductor device from a client, the company A is supplied with the mask 6. At this time, the product name 1201, the version number 1202, the photomask name 1203, the mask lot number 1204, the contact information of a person involved 1205, the contact information of a client 1208, and the storage cabinet address 1209 are registered in the mask management database 120 of the second server 12.

FIG. 10A shows a status where the above-described information is registered in the mask management database 120.

The company A performs manufacturing as usual until the client requests disposal.

Next, a process of disposing the mask 6 is described.

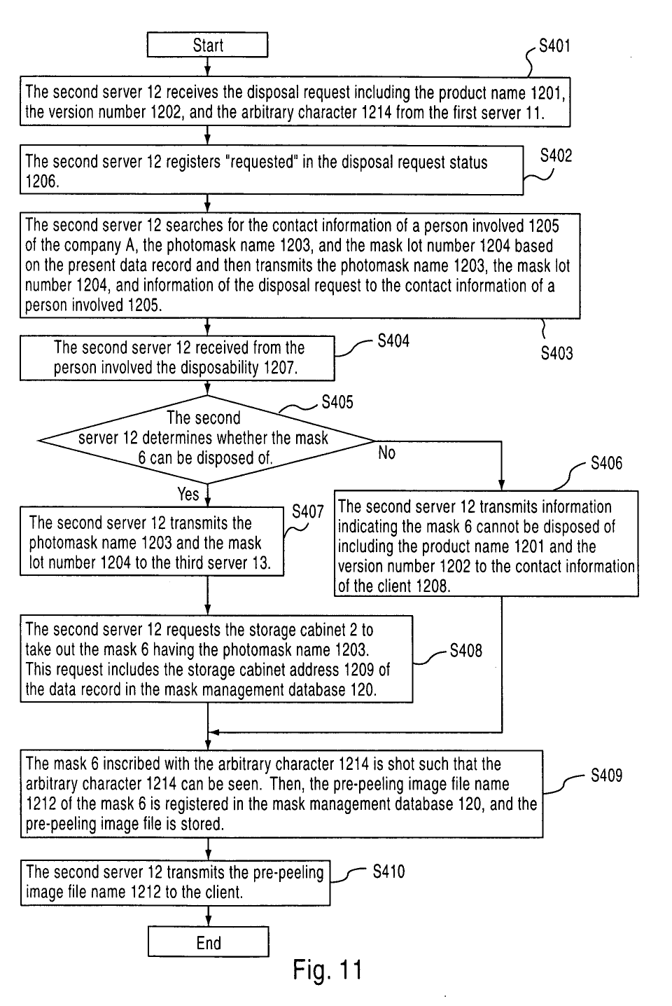

FIG. 11 is a flowchart of a process performed in the second server 12 according to the second embodiment. With reference to this flowchart, a process from receiving a request to dispose of the mask 6 until transmitting the mask 6 to the disposing side is described.

When the client wants to dispose of the mask 6, the client inputs a client ID, a password, and so on to the client terminal 5 in order to log in the mask disposal accepting system included in the first server 11, which is a server for outside persons involved of the company A. The mask disposal accepting system accepts the disposal request. Also, if the client requests browsing image data of the mask 6 after the mask 6 has been disposed of, the mask disposal accepting system displays the image data. The client inputs the product name 1201 and the version number 1202 of the semiconductor device corresponding to the mask 6 to be disposed of and the arbitrary character 1214 to the client terminal 5 and transmits a disposal request to the first server 11. The arbitrary character 1214 is a character, a character string, or a figure to be inscribed on the mask 6 by a CO₂ laser.

The first server 11 receives the disposal request including the product name 1201 and the version number 1202 of the semiconductor device from the client and transmits the product name 1201 and the version number 1202 to the second server 12 for inside staff involved.

The second server 12 determines whether a data record corresponding to the product name 1201 and the version number 1202 exists in the mask management database 120. If the data record does not exist, the second server 12 transmits information indicating the data record does not exist to the first server 11 and requests re-input.

At the time when the client logs in the mask disposal accepting system in the first server 11, the client can be identified, a data record in the mask management database 120 of the second server 12 can be searched for the product name 1201 and the version number 1202 corresponding to the client information, and a list of semiconductor products can be displayed on the screen of the client terminal 5. In this case, one of the semiconductor products displayed on the screen can be selected by the client.

If the second server 12 determines that the mask management database 120 has the data record corresponding to the product name 1201 and the version number 1202 received from the first server 11, the second server 12 receives the disposal request including the product name 1201, the version number 1202, and the arbitrary character 1214 from the first server 11 (S401).

After receiving the disposal request, the second server 12 registers “requested” in the disposal request status 1206 of the mask management database 120 (S402).

FIG. 10B shows a status where “requested” is registered in the disposal request status 1206 of the mask management database 120 and also the arbitrary character 1214 is registered.

Then, the second server 12 searches for the contact information of a person involved 1205 of the company A, the photomask name 1203, and the mask lot number 1204 based on the present data record and then transmits the photomask name 1203, the mask lot number 1204, and information of the disposal request to the contact information of a person involved 1205 (S403).

The person involved receives the notification in step S403, determines whether the mask can be disposed of based on the photomask name 1203 and the mask lot number 1204, and transmits the determination result as determination information of the disposability 1207 of the mask management database 120 to the second server 12. The second server 12 determines whether the mask 6 can be disposed of (S405) based on the determination information received from the person involved (S404).

FIG. 10C shows a status where the disposability 1207 is registered in the mask management database 120.

If the determination information of the disposability 1207 of the mask 6 received from the person involved indicates “impossible” (No in step S405), information indicating the mask 6 cannot be disposed of including the product name 1201 and the version number 1202 is transmitted to the contact information of the client 1208 (S406). On the other hand, if the determination information of the disposability 1207 of the mask 6 received from the person involved indicates “possible” (Yes in S405), the photomask name 1203 and the mask lot number 1204 are transmitted to the third server 13 of the company B as a prior announcement of the request to dispose of the mask 6 (S407).

The second server 12 requests the storage cabinet 2 to take out the mask 6 having the photomask name 1203. This request includes the storage cabinet address 1209 of the data record in the mask management database 120 (S408). The storage cabinet 2 receives the request and takes the mask 6 corresponding to the storage cabinet address 1209 from the storage cabinet 2.

The taken mask 6 is transmitted to the company B.

The mask 6 taken out of the storage cabinet 2 is inscribed with the arbitrary character 1214. In this embodiment, the arbitrary character 1214 is inscribed on the mask 6 by using a CO₂ laser.

The mask 6 inscribed with the arbitrary character 1214 is shot such that the arbitrary character 1214 can be seen. Then, the pre-peeling image file name 1212 of the mask 6 is registered in the mask management database 120, and the pre-peeling image file is stored (S409).

FIG. 10D shows a status where the pre-peeling image file name 1212 is registered in the mask management database 120.

The registered name of image is transmitted to the client so that the client can see the image (S410). Since the image file before peeling can be checked, the reliability of a peeling operation increases and the image can be easily checked by the client.

Then, the mask 6 is transmitted to the company B.

The company B performs a usual peeling process by using the disposing device 31 of the disposing unit 3. The bare glass substrate 61 after the peeling process is returned to the company A.

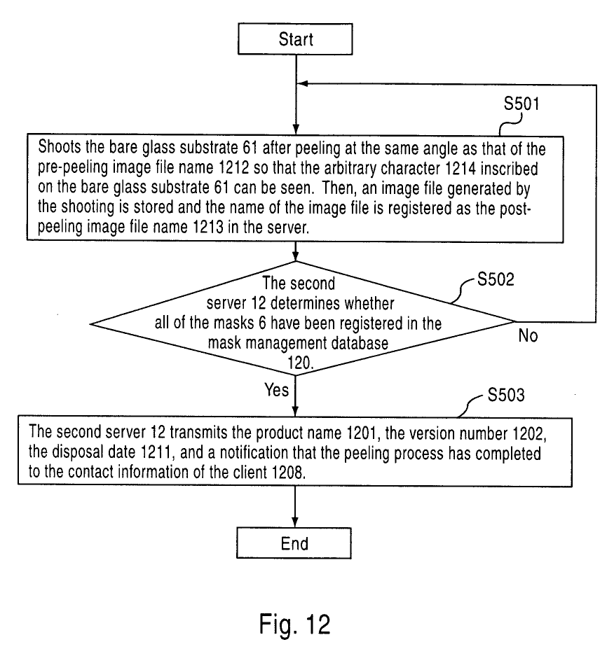

FIG. 12 is a flowchart (2) of a process performed in the server 12 according to the second embodiment. This flowchart illustrates a process of registering an image of a peeled mask performed in the company A after completion of disposal has been notified from the company B.

The person involved of the company A shoots the bare glass substrate 61 after peeling at the same angle as that of the pre-peeling image file name 1212 so that the arbitrary character 1214 inscribed on the bare glass substrate 61 can be seen. Then, an image file generated by the shooting is stored and the name of the image file is registered as the post-peeling image file name 1213 in the server (S501).

FIG. 10E shows a status where the post-peeling image file name 1213 is registered in the mask management database 120.

If not all of the masks have been disposed of (No in step S502), the process waits until completion of disposal of all of the masks 6 is registered.

On the other hand, if all of the masks 6 have been disposed of (Yes in step S502), the product name 1201, the version number 1202, the disposal date 1211, and a notification that the peeling process has completed are transmitted to the contact information of the client 1208 (S503).

In step S502, a notification may be transmitted to the client every time one mask 6 has been disposed of. In step S503, the information and notification may be directly transmitted from the second server 12 to the client terminal 5 or may be transmitted through the first server 11 to the client terminal 5.

When the client wants to check the peeled mask 6, the client logs in the mask disposal accepting system of the first server 11 through the client terminal 5 and inputs the product name 1201, the version number 1202, and an image browsing request.

The second server 12 receives the product name 1201, the version number 1202, and the image browsing request from the first server 11, extracts a data record corresponding to the product name 1201 and the version number 1202 from the mask management database 120, reads the image file name 1210 of the data record, and transmits the image files corresponding to the pre-peeling image file name 1212 and the post-peeling image file name 1213 to the first server 11.

### Third Embodiment

In FIG. 3, three servers connect to each other through a network. The first server 11 and the second server 12 are placed in the company A, whereas the third server 13 is placed in the company B together with the disposing unit 3 and the disposal verifying unit 4. In the example shown here, the company A is the semiconductor device manufacturer 7 and the company B is the mask manufacturer 71. The company B supplies masks 6 to the company A along the arrow 90.

When the company B purchases substrates for the masks 6, the company B purchases virgin substrates 62 with serial numbers and manages them. When the masks 6 are supplied from the company B, the company A registers the serial numbers and mask IDs of the respective masks 6 in the second server 12 so that a client can browse them, and stores the masks 6 in the storage cabinet 2 along the arrow 91.

When the client accesses the first server 11 of the company A through the client terminal 5 and requests disposal of the mask 6, the disposal request is registered in the second server 12 along the arrow 81. Then, the second server 12 notifies the storage cabinet 2 along the arrow 82 and the third server 13 placed in the company B along the arrow 83 that the disposal request has been received. Accordingly, the storage cabinet 2 takes the specified mask 6 out of storage and transmits the mask 6 to the company B along the arrow 84.

The company B receives the mask 6 and performs a disposal operation by using the disposing unit 3 so that the mask pattern becomes unreadable. The typical disposing unit 3 peels the pattern by using the disposing device 31 as in the above-described embodiments and obtains the bare glass substrate 61.

After the disposal of the mask 6 by peeling has been done, a verifying process is performed by using the disposal verifying unit 4 so that the client can verify that the mask 6 has been disposed of. Typically, the serial number of the bare glass substrate 61 and mask information such as a mask ID are shot in one frame by the disposal verifying device 41 such as a video camera. The image and mask information are registered in the third server 13 along the arrow 85.

The third server 13 transmits the verifying information of the disposal process registered by the disposal verifying unit 4 as disposal track record information to the second server 12 of the company A along the arrow 86. The second server 12 registers the disposal track record information therein so that the client can browse it. Accordingly, the client can verify that the mask 6 has been disposed of through the client terminal 5 by accessing the first server 11 and by comparing the information about the mask 6 before disposal with the disposal track record information registered in the second server 12, that is, the serial number of the bare glass substrate 61 and mask information such as the mask ID.

The second server 12 includes the mask management database 120.

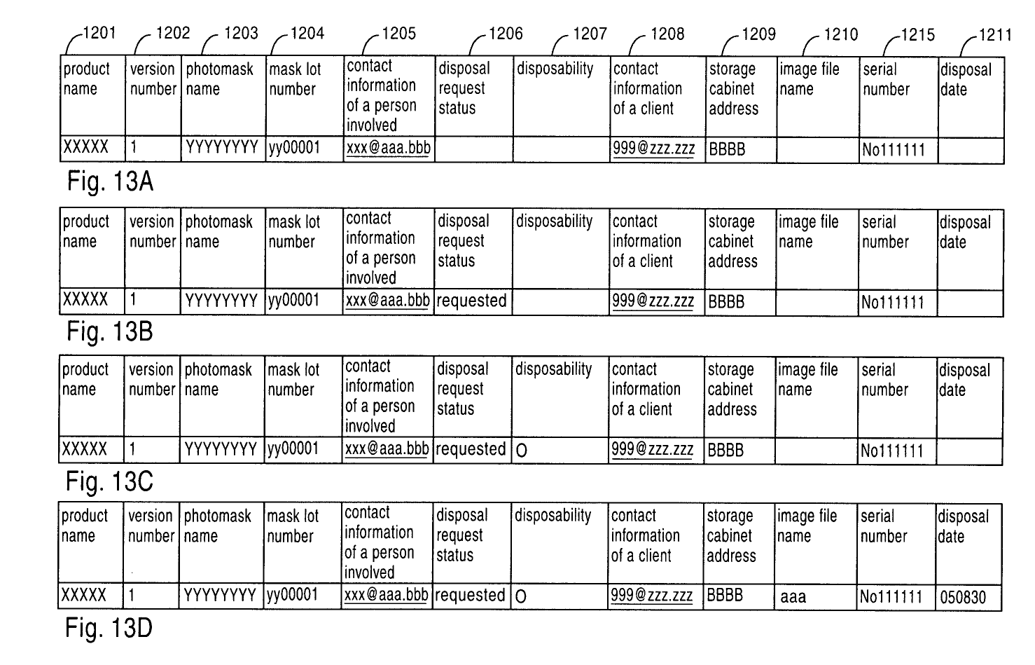

FIGS. 13A to 13D show the configuration of the mask management database 120 included in the second server 12 according to the third embodiment.

The mask management database 120 is composed of the following items: product name 1201, version number 1202, photomask name 1203, mask lot number 1204, contact information of a person involved 1205, disposal request status 1206, disposability 1207, contact information of a client 1208, storage cabinet address 1209, image file name 1210, serial number 1215, and disposal date 1211.

Among these items constituting the mask management database 120, the same items as those in the first embodiment have the same function and thus the corresponding description is not repeated.

The mask management database 120 of the third embodiment is different from that of the first embodiment in that the serial number 1215 is provided.

The serial number 1215 is fixed when the virgin substrate 62 is supplied.

The image file corresponding to the image file name 1210 is the same as the image file of the first embodiment in its item. However, the image file in the third embodiment is different from the image file corresponding to the image file name 1210 of the first embodiment in that the serial number 1215 of the mask 6 is placed within the frame.

Next, a registration status of the mask management database 120 before a mask disposing process starts is described.

When receiving an order to manufacture a semiconductor device from a client, the company A as the semiconductor device manufacturer 7 requests manufacturing masks 6 of the semiconductor device to the mask manufacturer 71. Accordingly, the mask manufacturer 71 receives substrates for manufacturing the masks 6 from a mask substrate manufacturer (not shown).

The mask substrate manufacturer manufactures and sells substrates while assigning serial numbers 1215 to the respective substrates.

FIG. 19 shows an example of the configuration of the peeling operation database 130 included in the third server 13 according to the third embodiment. The peeling operation database 130 is composed of the following items: photo mask name 1203, mask lot number 1204, image file name 1210, serial number 1215, and disposal date 1211. These items correspond to the data items of the mask management database 120 according to this embodiment.

The third server 13 of the mask manufacturer 71 manufactures the mask 6, registers it in the peeling operation database 130, and transmits the photomask name 1203, the mask lot number 1204, and the serial number 1215 to the second server 12. The second server 12 receives the photomask name 1203, the mask lot number 1204, and the serial number 1215 from the third server 13 and registers the data items in the mask management database 120. Also, the second server 12 registers the mask lot number 1204 and the serial number 1215 corresponding to the product name 1201, the version number 1202, the photomask name 1203, the contact information of a person involved 1205, and the contact information of a client 1208 in the mask management database 120.

After the mask 6 has been supplied to the company A, the substrate of the mask 6 is stored in the storage cabinet 2.

The second server 12 of the company A registers the storage cabinet address 1209 in the data record of the mask management database 120 corresponding to the substrate of the mask 6.

FIG. 13A shows a status where each data item is registered in the mask management database 120.

The second server 12 notifies the contact information of the client 1208 of the registered serial number 1215.

Then, the company A as a semiconductor device manufacturer manufactures semiconductor devices as usual.

A process performed after the company A receives a request to dispose of the mask 6 from the client until the company A transmits the mask 6 to the company B is the same as that in the first embodiment. That is, the process is performed in accordance with the flowchart shown in FIG. 7, which is used in the first, third, fourth, and fifth embodiments. The description of the process is omitted.

Next, a peeling operation in the company B is described.

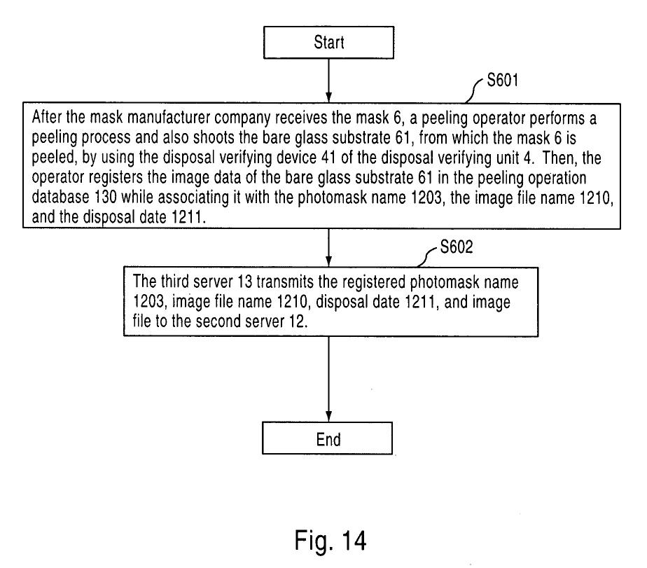

FIG. 14 is a flowchart of a process performed in the third server 13 according to the third embodiment.

After the company B receives the mask 6, a peeling operator performs a peeling process and also shoots the bare glass substrate 61, from which the mask 6 is peeled, by using the disposal verifying device 41 of the disposal verifying unit 4. Then, the operator registers the image data of the bare glass substrate 61 in the peeling operation database 130 while associating it with the photomask name 1203, the image file name 1210, and the disposal date 1211 (S601).

Incidentally, the image is taken so that the serial number on the bare glass substrate 61 can be recognized.

The third server 13 transmits the registered photomask name 1203, image file name 1210, disposal date 1211, and image file to the second server 12 (S602).

The image registering process performed in the company A after receiving notification of completion of disposal from the company B is the same as that shown in the flowchart (2) of the second server 12 according to the first embodiment. That is, the process is performed in accordance with the flowchart (2) shown in FIG. 9 according to the first and third embodiments, and thus the corresponding description is omitted.

When the client wants to see the image of the peeled mask 6, the client logs in the disposal accepting system of the mask 6 of the first server 11 through the client terminal 5 and inputs the product name 1201, the version number 1202, and an image browsing request.

The second server 12 receives the product name 1201, the version number 1202, and the image browsing request from the first server 11, extracts the data record corresponding to the product name 1201 and the version number 1202 from the mask management database 120, reads the image file name 1210 of the data record, and transmits the image file corresponding to the image file name 1210 to the first server 11.

At this time, the serial number that was notified when the semiconductor device was manufactured can be seen in the image file of the bare glass substrate 61 after peeling, and thus disposal of the mask 6 can be verified.

### Fourth Embodiment

In FIG. 4, two servers connect to each other through a network. The first server 11 and the second server 12 are placed in the company A, which is also provided with the disposal verifying unit 4. The company B includes the disposing unit 3. In the example shown here, the company A is the semiconductor device manufacturer 7 and the company B is the mask manufacturer 71 including the disposing unit 3. The company B supplies masks 6 to the company A.

After the company A is supplied with the mask 6 from the company B along the arrow 90, a correction marker 63 is intentionally attached on the mask 6 in an area other than a mask device pattern by etching of an FIB (focused ion beam) process so that the substrate can be specified. This correction marker 63 is shot by the disposal verifying device 41 of the disposal verifying unit 4, e.g., an SEM (scanning electron microscope), and the axis of coordinates thereof is registered in the second server 12.

When the client terminal 5 accesses the first server 11 of the company A in order to transmit a request to dispose of the mask 6 to be discontinued, the request is registered in the second server 12 along the arrow 81, so that the second server 12 provides instructions to take the mask 6 out of storage to the storage cabinet 2 along the arrow 82. The storage cabinet 2 receives the instructions, takes out the specified mask 6, and transmits the mask 6 to the company B along the arrow 84.

The company B receives the mask 6 to be disposed of from the company A and performs a disposal process by using the disposing unit 3. The disposal process is performed by peeling a mask pattern by using the disposing device 31 so that the mask pattern becomes unreadable. Then, the company B transmits the bare glass substrate 61 after peeling to the company A along the arrow 88.

The company A receives the bare glass substrate 61, shoots the correction marker 63 attached on the mask 6 by the SEM or the like of the disposal verifying unit 4 in order to verify that disposal has been reliably done, and registers the image of the correction marker 63 in the second server 12. Then, the verifying process completes.

Accordingly, by accessing the first server 11 through the client terminal 5, the client can compare the correction marker 63 of the original mask 6 registered in the second server 12 with the correction marker 63 on the disposed of bare glass substrate 61. As a result, the client can verify that the disposal process has reliably been done.

The second server 12 includes the mask management database 120.

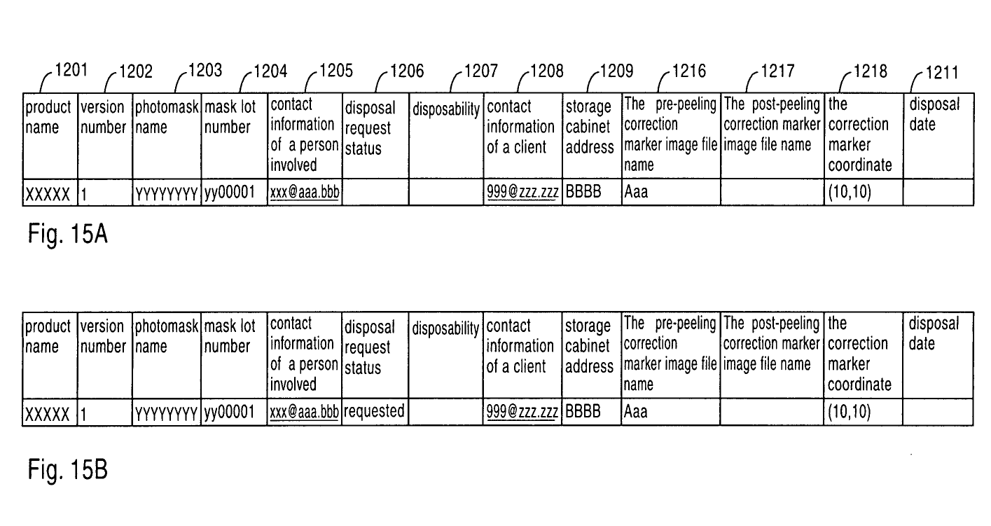

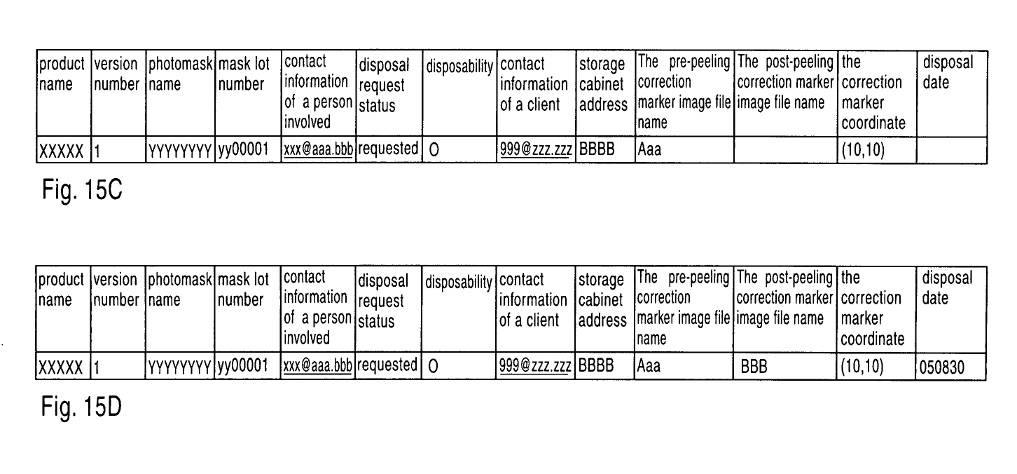

FIGS. 15A to 15D show the configuration of the mask management database 120 included in the second server 12 according to the fourth embodiment.

The mask management database 120 is composed of the following items: product name 1201, version number 1202, photomask name 1203, mask lot number 1204, contact information of a person involved 1205, disposal request status 1206, disposability 1207, contact information of a client 1208, storage cabinet address 1209, pre-peeling correction marker image file name 1216, post-peeling correction marker image file name 1217, correction marker coordinate 1218, and disposal date 1211.

Among these items constituting the mask management database 120, the same items as those in the first embodiment have the same function, and thus the corresponding description is not repeated.

The mask management database 120 of the fourth embodiment is difference from that of the first embodiment in that the pre-peeling correction marker image file name 1216, the post-peeling correction marker image file name 1217, and the correction marker coordinate 1218 are provided.

The pre-peeling correction marker image file name 1216 is the name of an image file obtained by attaching a marker on the substrate of the mask 6 before peeling by an FIB and by shooting the marker using an SEM.

The post-peeling correction marker image file name 1217 is the name of an image file obtained by shooting the substrate of the mask 6 after peeling at the same angle as that of the image file before peeling by using the SEM.

The correction marker coordinate 1218 is a coordinate value indicating the position where the marker is attached on the mask 6 by the FIB.

Next, a registration status of the mask management database 120 before a mask disposing process starts is described.

After receiving an order to manufacture a semiconductor device from a client, the company A is supplied with the mask 6. At this time, the product name 1201, the version number 1202, the photomask name 1203, the mask lot number 1204, the contact information of a person involved 1205, the contact information of a client 1208, and the storage cabinet address 1209 are registered.

At this time, the company A attaches the correction marker 63 on the mask 6 in an area having no effect on manufacturing the semiconductor device by etching of an FIB process or the like. The disposal verifying device 41 of the disposal verifying unit 4 registers coordinate data indicating the position of the correction marker 63 on the mask 6 as the correction marker coordinate 1218 in the mask management database 120. Also, the disposal verifying device 41 obtains the image data of the correction marker 63 by using the SEM or the like and registers the image data as the pre-peeling correction marker image file name 1216 in the mask management database 120.

FIG. 15A shows a registration status of the mask management database 120.

Until receiving a disposal request from the client, the company A performs manufacturing as usual.

The process of the fourth embodiment performed after the company A receives a request to dispose of the mask 6 from the client until the company A transmits the mask 6 to the company B is the same as the process shown in FIG. 7, which has been described in the first embodiment. Also, the mask disposing process in the company B is the same as the process shown in FIG. 8, which has been described in the first embodiment. Therefore, the corresponding description is not repeated.

After the mask 6 has been peeled in the company B, the bare glass substrate 61 is transmitted to the company A.

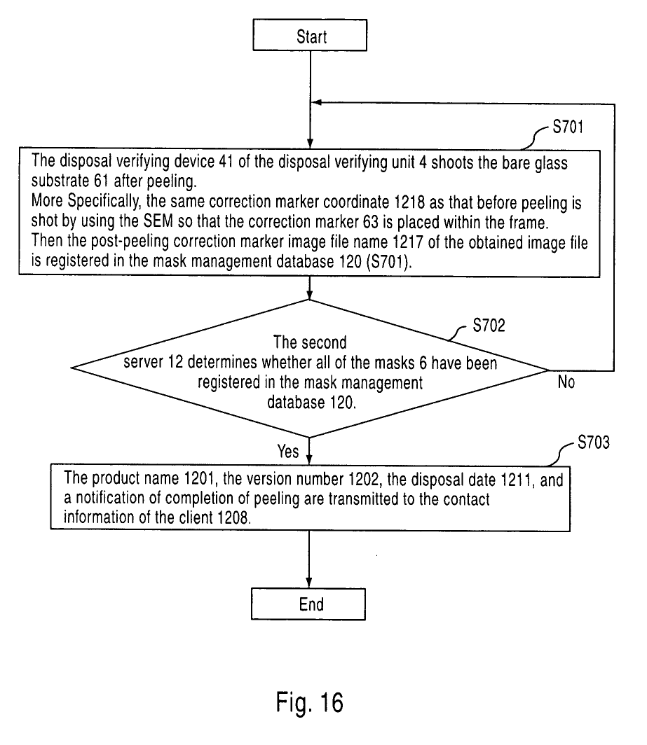

FIG. 16 is a flowchart (2) of a process performed in the second server 12 according to the fourth embodiment. This flowchart illustrates a process performed after the bare glass substrate 61 has been transmitted from the company B to the company A.

The disposal verifying device 41 of the disposal verifying unit 4 shoots the bare glass substrate 61 after peeling. More specifically, the same correction marker coordinate 1218 as that before peeling is shot by using the SEM so that the correction marker 63 is placed within the frame. Then, the post-peeling correction marker image file name 1217 of the obtained image file is registered in the mask management database 120 (S701).

FIG. 15D shows a status where the post-peeling correction marker image file name 1217 is registered in the mask management database 120.

If not all of the masks have been disposed of (No in step S702), the process waits until completion of disposal of all of the masks 6 is registered.

On the other hand, if all of the masks have been disposed of (Yes in step S702), the product name 1201, the version number 1202, the disposal date 1211, and a notification of completion of peeling are transmitted to the contact information of the client 1208 (S703).

When the client wants to check the peeled mask 6, the client logs in the disposal accepting system of the mask 6 in the first server 11 through the client terminal 5 and inputs the product name 1201 and the version number 1202.

The second server 12 receives the product name 1201, the version number 1202, and the image browsing request from the first server 11, searches for the data record corresponding to the product name 1201 and the version number 1202 from the mask management database 120, reads the pre-peeling correction marker image file name 1216 and the post-peeling correction marker image file name 1217 in the data record, and transmits the image files corresponding to the pre-peeling correction marker image file name 1216 and the post-peeling correction marker image file name 1217 to the first server 11.

### Fifth Embodiment

In FIG. 5, three servers connect to each other through a network. The first server 11 and the second server 12 are placed in the company A, whereas the third server 13 is placed in a company C. The company B is provided with the disposing unit 3. In the example shown here, the company A is the semiconductor device manufacture 7, the company B is the mask manufacturer 71, and the company C is the mask substrate manufacturer 73.

Before supplying substrates to the company B as the mask manufacturer 71, the company C as the mask substrate manufacturer 73 performs measurement so that the respective substrates can be specified. For example, the characteristics of quartz substrates supplied as virgin substrates 62, including the roughness, flatness, and thickness of the substrates, are measured.

Herein, the characteristics of the substrates are measured in the following manner. The roughness is measured by in-plane measurement using an AFM (atomic force microscope), the flatness is measured by in-plane measurement using a laser interferometer, and the thickness is measured by in-plane measurement using a laser displacement gauge.

The company C supplies the substrates together with the measurement result of the substrates to the company B as the mask manufacturer 71 along the arrow 92. The company B manufactures masks 6 and transmits the masks 6 together with the measurement result received from the company C to the company A as the semiconductor device manufacturer 7 along the arrow 90.

The company A registers the measurement result of the characteristics of the virgin substrates 62 received from the company B in the second server 12 along the arrow 93, and uses or stores the supplied masks 6.

When the client wants to dispose of an unnecessary mask 6 to be discontinued, the client accesses the first server 11 of the company A through the client terminal 5, so that the request is registered in the second server 12 through the first server 11 along the arrow 81. Then, the second server 12 transmits the disposal request to the storage cabinet 2 along the arrow 82. Accordingly, the storage cabinet 2 takes the specified mask 6 out of storage and transmits the mask 6 to the company B along the arrow 84.

The company B receives the mask 6 to be disposed of from the company A and performs a disposal process by using the disposing unit 3. In this disposing process, the mask pattern is peeled off by using the disposing device 31, for example. After the mask 6 has been peeled off, the bare glass substrate 61 is returned to the company A along the arrow 88.

After the company A transmits the returned bare glass substrate 61 to the company C as the mask substrate company 73 along the arrow 95, the company C measures the characteristics of the disposed of bare glass substrate 61. Then, the company C transmits the measurement result to the second server 12 of the company A through the third server 13 along the arrow 93. The company A compares the characteristics of the mask 6 with those of the disposed of bare glass substrate 61 so as to verify that the mask 6 has been disposed of, and then registers the comparison result in the second server 12.

The client who requested disposal can verify that the disposal has been done by accessing the first server 11 from the client terminal 5 and by browsing the comparison result registered in the second server 12.

The second server 12 includes the mask management database 120.

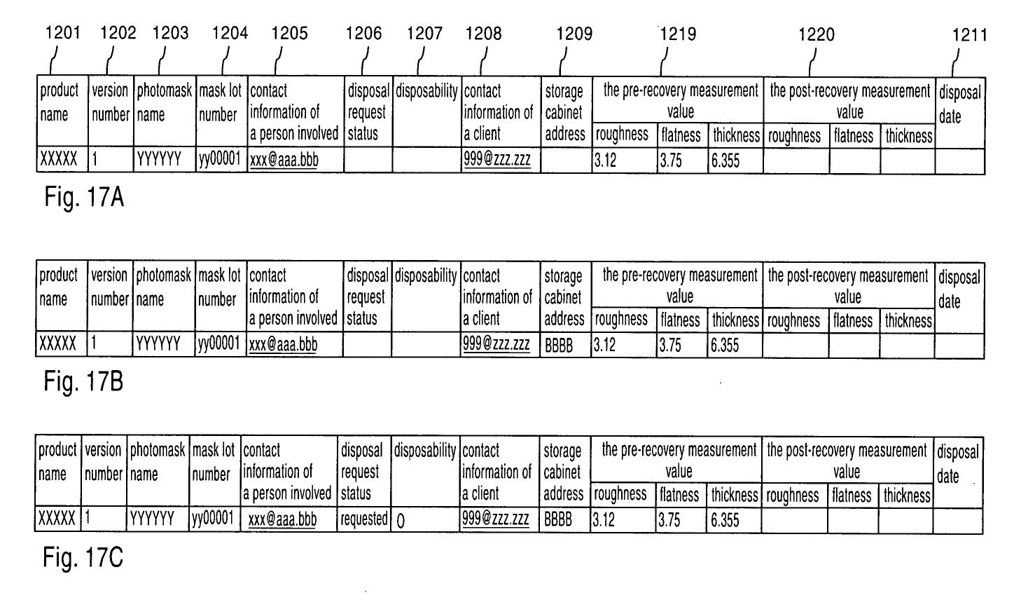

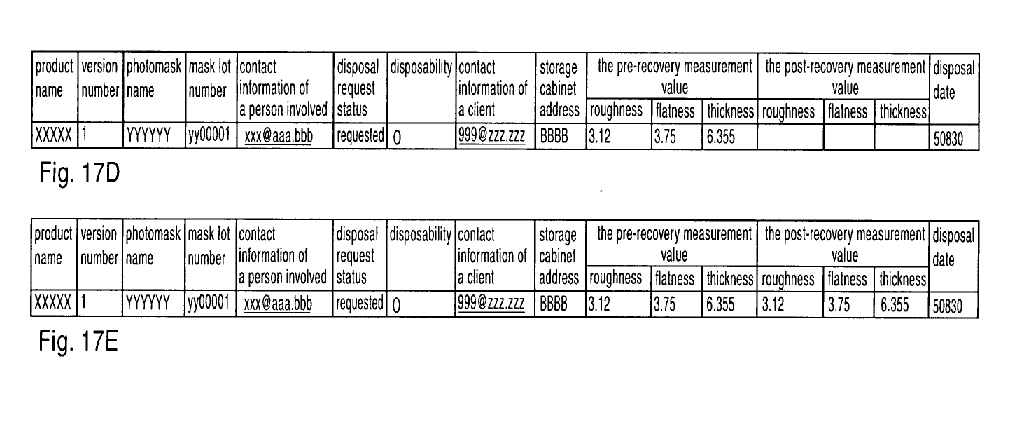

FIGS. 17A to 17E show the configuration of the mask management database 120 included in the second server 12 according to the fifth embodiment.

The mask management database 120 is composed of the following items: product name 1201, version number 1202, photomask name 1203, mask lot number 1204, contact information of a person involved 1205, disposal request status 1206, disposability 1207, contact information of a client 1208, storage cabinet address 1209, pre-disposal measurement value 1219 (roughness, flatness, and thickness), post-disposal measurement value 1220 (roughness, flatness, and thickness), and disposal date 1211.

Among these items constituting the mask management database 120, the same items as those in the first embodiment have the same function, and thus the corresponding description is not repeated.

The mask management database 120 of the fifth embodiment is different from that of the first embodiment in that the pre-disposal measurement value 1219 (roughness, flatness, and thickness) and the post-disposal measurement value 1220 (roughness, flatness, and thickness) are provided.

The pre-disposal measurement value 1219 (roughness, flatness, and thickness) is a value obtained when the company C as the mask substrate manufacturer 73 manufactures the virgin substrate 62. Then, the company B as the mask manufacturer 72 manufactures the mask 6 based on the virgin substrate 62. The measurement value is different in each virgin substrate 62.

The post-disposal measurement value 1220 (roughness, flatness, and thickness) is a value obtained when the company C measures the bare glass substrate 61 after the mask 6 has been peeled.

Next, a registration status of the mask management database 120 before disposal of the mask 6 starts is described.

The company C as the mask substrate manufacturer 73 measures the roughness, flatness, thickness, and so on of the virgin substrate 62. The measurement result is supplied as the pre-disposal measurement value 1219 together with the mask 6 to the company A through the company B.

At the time when the company A receives the mask 6, the mask lot number 1204 and the pre-disposal measurement value 1219 are registered in the record corresponding to the product name 1201, the version number 1202, and the photomask name 1203.

The supplied mask 6 is stored in the storage cabinet 2.

FIG. 17A shows the registration status of the mask management database 120.

Then, the company B performs manufacturing as usual until receiving a disposal request from the client.

The process of the fifth embodiment performed after the company A receives a request to dispose of the mask 6 from the client until the company A transmits the mask 6 to the company B is the same as in the first embodiment. That is, the process is performed in accordance with the flowchart shown in FIG. 7, which is used in the first, third, fourth, and fifth embodiments. Therefore, the corresponding description is not repeated.

In the company B, a peeling process is performed on the transmitted mask 6 by the disposing device 31 of the disposing unit 3, the photomask name 1203, the mask lot number 1204, and the disposal date 1211 are transmitted to the second server 12, and the bare glass substrate 61 after the mask 6 has peeled off is returned to the company A.

When receiving the photomask name 1203, the mask lot number 1204, and the disposal date 1211, the second server 12 registers the disposal date 1211 in the data record of the mask management database 120.

FIG. 17D shows a status where the disposal date 1211 is registered in the mask management database 120.

The company A transmits the bare glass substrate 61 returned from the company B to the company C.

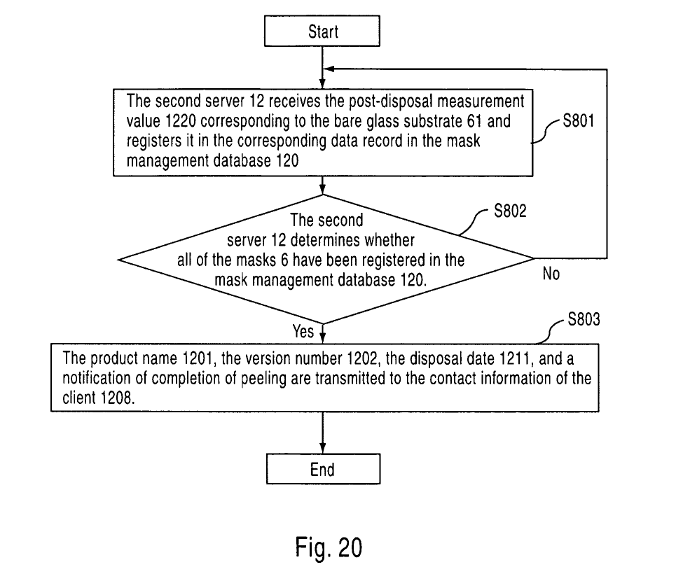

FIG. 20 is a flowchart (2) of a process performed in the server 12 according to the fifth embodiment. This flowchart illustrates a process of registering data performed after the company A has transmitted the mask 6 to the company C.

The company C measures the roughness, flatness, thickness, and so on of the transmitted bare glass substrate 61. After the measurement value has been registered in the third server 13, the third server 13 transmits the measurement value as the post-disposal measurement value 1220 to the second server 12 of the company A. The second server 12 of the company A receives the post-disposal measurement value 1220 corresponding to the bare glass substrate 61 and registers it in the corresponding data record in the mask management database 120 (S801).

FIG. 17E shows a status where the post-disposal measurement value 1220 is registered in the mask management database 120.

If not all of the masks 6 have been disposed of (No in step S802), the process waits until completion of disposal of all of the masks 6 has been registered.

On the other hand, if all of the masks 6 have been disposed of (Yes in step S802), the product name 1201, the version number 1202, the disposal date 1211, and a notification of completion of disposal are transmitted to the contact information of the client 1208 (S803).

When the client wants to check the peeled mask 6, the client logs in the disposal accepting system of the mask 6 in the first server 11 through the client terminal 5 and inputs the product name 1201 and the version number 1202.

The second server 12 receives the product name 1201, the version number 1202, and the browsing request from the first server 11, extracts the data record corresponding to the product name 1201 and the version number 1202 from the mask management database 120, reads the pre-disposal measurement value 1219 and the post-disposal measurement value 1220 in the data record, and transmits those values to the first server 11.

In each of the above-described embodiments, when the client wants to dispose of an unnecessary mask or a mask to be discontinued, the client only has to transmit a disposal request to the semiconductor device manufacturer through the client terminal, which is convenient.

The semiconductor device manufacturer that receives the disposal request can request a disposal operation to a mask manufacturer having a disposing unit and obtain a disposal result from a disposal verifying unit of the mask manufacturer or the own company so as to verify that the mask has been reliably disposed of. Further, the client can browse the result through the client terminal.

The semiconductor device manufacturer, the mask manufacturer, the disposing company, and the substrate manufacturer may be independent from each other. Alternatively, one company may function as some of those companies, and other various modifications can be accepted.

Therefore, the placement of a series of elements including a plurality of servers required for disposal in the semiconductor device manufacturer, the mask manufacturer, the disposing company, and the substrate manufacturer is not specified but various modifications can be accepted.

The method adopted in the disposing device used in the disposing unit is not limited to peeling of the mask pattern. Other various modifications can also be used as long as the evidence of disposal can be obtained.

In the disposal verifying device of the disposal verifying unit, various methods of verifying the disposal may be used. For example, the evidence of disposal may be converted to image data or numerical data. Other various modifications may also be applied.

In the above-described embodiments, the first server 11 and the second server 12 are separated from each other. However, the processes may be performed by a single server.

A case of disposing masks for manufacturing semiconductor devices, which use many masks, has been described above. The present invention can also be applied to disposal of masks for manufacturing LCDs, PDPs, or printed boards, and can be preferably used to ensure the confidentiality of masks having a design circuit pattern.

What is claimed is:

1. A mask disposing system, comprising:
an input interface unit receiving a request to dispose of the masks;
a database storing the request;
an output unit taking the masks in response to the request;
an associating unit associating the request stored in the database with a mask disposal information; and
an output interface unit transmitting a mask disposal completion information after the mask disposal information is associated with the associating unit.

2. The mask disposing system according to claim 1,
wherein the output interface unit transmits a registered post-peeling mask information when the input interface unit receives an information checking request.

3. The mask disposing system according to claim 1,
wherein the output interface unit transmits a mask images in which the mask have been registered.

4. The mask disposing system according to claim 1, further comprising:
a pre-peeling image obtaining unit inscribing an arbitrary character on each mask and obtaining a mask image in which the inscribed arbitrary character can be seen before transmitting the mask,
wherein the associating unit associates an image of each post-peeling mask with the same layout as that the pre-peeling image after a bare glass substrate as a post-peeling mask.

5. The mask disposing system according to claim 4, wherein the pre-peeling image obtaining unit stores a coordinate of a position where the arbitrary character is inscribed.

6. The mask disposing system according to claim 1, wherein the associating unit associates the request stored in the database with a mask information after receiving a result of a mask peeling process and the mask information in which a serial number attached on the mask can be seen.

7. The mask disposing system according to claim 1, further comprising:
a measurement result database unit storing a pre-peeling mask measurement value including a measurement result of at least one of a roughness, flatness, and thickness of each mask in advance;
a second associating unit storing the request and the value while associating them with each other; and
a third associating unit associating the request stored in the database with a post-peeling mask measurement value.

8. A method of a mask disposing, comprising:
receiving a request to dispose of the masks;
storing the request;
taking the masks in response to the request;
associating the request with a mask disposal information; and
transmitting a mask disposal completion information.

9. The method as defined in claim 8, wherein the transmitting transmits a registered post-peeling mask information when an input interface unit receives an information checking request.

10. The method as defined in claim 8, wherein the transmitting transmits an mask images in which the mask have been registered.

11. The method as defined in claim 8, further comprising:
inscribing an arbitrary character on each mask; and
obtaining a mask image in which the arbitrary character can be seen before the associating;
wherein the associating associates an image of each post-peeling mask with the same layout as that the pre-peeling image after a bare glass substrate as a post-peeling mask.

12. The method as defined in claim 11, wherein the obtaining stores a coordinate of a position where the arbitrary character is inscribed.

13. The method as defined in claim 8, wherein the associating associates the request with a mask information after receiving a result of a mask peeling process and the mask information in which a serial number attached on the mask can be seen.

14. The method as defined in claim 8, further comprising:
storing a pre-peeling mask measurement value including a measurement result of at least one of a roughness, flatness, and thickness of each mask in advance;
storing the request and the value while associating them with each other; and
associating the request stored in the database with a post-peeling mask measurement value.
